(19) United States
(12) Patent Application Publication
(10) Pub. No.: US 2014/0068423 A1
(43) Pub. Date: Mar. 6, 2014

(54) INFORMATION PROCESSING APPARATUS, INFORMATION PROCESSING METHOD, AND NON-TRANSITORY COMPUTER-READABLE MEDIUM

(71) Applicant: CANON KABUSHIKI KAISHA, Tokyo (JP)

(72) Inventor: Kazuya Nakashima, Yokohama-shi (JP)

(73) Assignee: CANON KABUSHIKI KAISHA, Tokyo (JP)

(21) Appl. No.: 13/960,345

(22) Filed: Aug. 6, 2013

(30) Foreign Application Priority Data
Aug. 29, 2012 (JP) 2012-188928

(51) Int. Cl. G06F 17/24

(52) U.S. Cl. CPC G06F 17/24
USPC 715/243

(57) ABSTRACT

An information processing apparatus comprises: a generation unit configured to generate one group object by grouping a plurality of objects; and a layout unit configured to lay out the group object in a state that an object of a predetermined attribute of the plurality of objects included in the group object is selected.

### BACKGROUND OF THE INVENTION

1. Field of the Invention

The present invention relates to an information processing apparatus, information processing method, and non-transitory computer-readable medium and, more particularly, to a presentation method of a selected state at the time of insertion of grouped objects in object editing processing of a document editing system.

2. Description of the Related Art

A technique for appending an annotation object as a page attribute to a page included in document data to be edited in a document editing system is known. The annotation object is not information of the original data of a document itself, but indicates an object which appends additional information to the original data. For example, a stamp object “for internal use only”, a marker object which appends marker information to a document of original data, and the like are known as examples of the annotation object.

When the user appends an annotation object to a plurality of documents, he or she has to repeat the same operation for the plurality of documents. For example, the user may insert a plurality of objects at prescribed positions in a template document each time in some cases. Japanese Patent Laid-Open No. 2005-11340 describes a technique for grouping objects and annotations.

However, Japanese Patent Laid-Open No. 2005-11340 does not consider improvement of user's operability after grouped objects are laid out.

### SUMMARY OF THE INVENTION

The present invention improves user's operability when grouped objects are laid out on a document.

According to one aspect of the present invention, there is provided an information processing apparatus comprising: a generation unit configured to generate one group object by grouping a plurality of objects; and a layout unit configured to lay out the group object in a state that an object of a predetermined attribute of the plurality of objects included in the group object is selected.

According to another aspect of the present invention, there is provided an information processing method comprising: a generation step of generating one group object by grouping a plurality of objects; and a layout step of laying out the group object in a state that an object of a predetermined attribute of the plurality of objects included in the group object is selected.

According to one aspect of the present invention, there is provided a non-transitory computer-readable medium storing a program for controlling a computer to function as: a generation unit configured to generate one group object by grouping a plurality of objects; and a layout unit configured to lay out the group object in a state that an object of a predetermined attribute of the plurality of objects included in the group object is selected.

An operation load on the user at the time of insertion of grouped objects can be reduced.

Further features of the present invention will become apparent from the following description of exemplary embodiments (with reference to the attached drawings).

### BRIEF DESCRIPTION OF THE DRAWINGS

FIG. 1 is a view showing an example of the arrangement of a system;

FIG. 2 is a block diagram showing an example of the hardware arrangement of an information processing apparatus;

FIG. 3 is a block diagram showing an example of the hardware arrangement of an image processing apparatus;

FIG. 4 is a block diagram showing an example of the software arrangement of a document editing system;

FIG. 5 is a view showing a UI display example of the document editing system;

FIG. 6 is a view showing an example of the data structure of an annotation object according to the first embodiment;

FIG. 7 is a table showing examples of types of annotation objects;

FIG. 8 is a view showing an example of the data structure of a registered object according to the first embodiment;

FIG. 9 is a view showing a display example upon selection of annotation objects;

FIG. 10 is a flowchart showing processing executed upon generation of a registered object according to the first embodiment;

FIG. 11 is a flowchart showing processing executed upon insertion of a registered object according to the first embodiment;

FIG. 12 is a view showing a display example upon selection of annotation objects according to the second embodiment;

FIG. 13 is a view showing an example of the data structure of annotation objects according to the second embodiment;

FIG. 14 is a view showing an example of the data structure of a registered object according to the second embodiment;

FIG. 15 is a flowchart showing processing at an annotation object edit start timing according to the second embodiment; and

FIG. 16 is a flowchart showing processing executed upon insertion of a registered object according to the second embodiment.

### DESCRIPTION OF THE EMBODIMENTS

### First Embodiment

Embodiments of the present invention will be described hereinafter with reference to the drawings.

[System Arrangement]

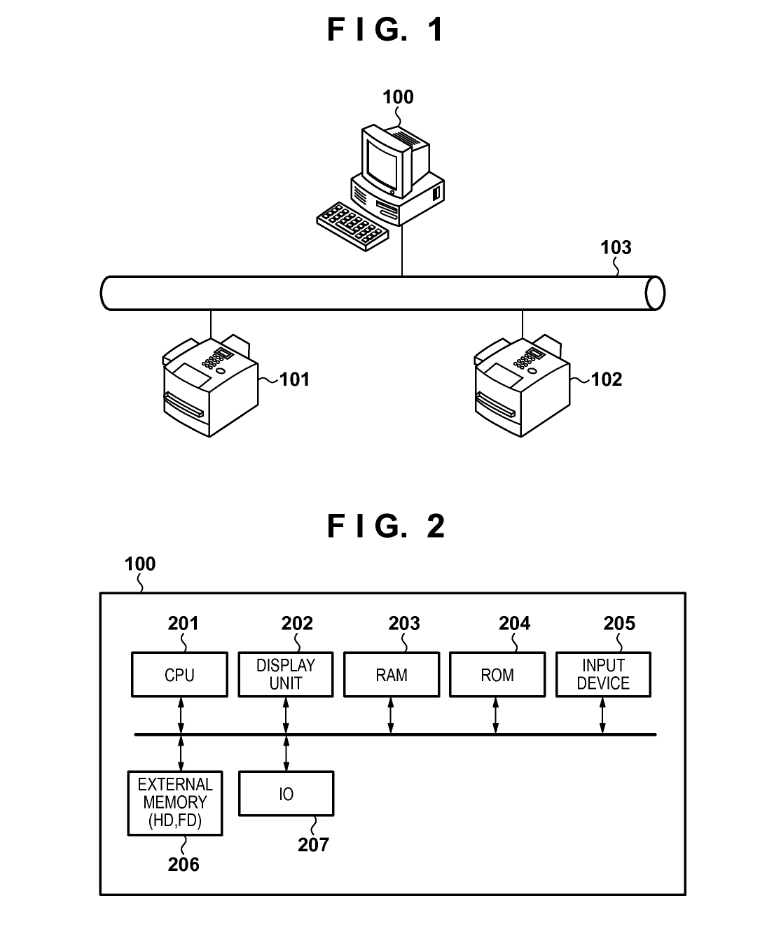

FIG. 1 is a view showing an example of the arrangement of a data processing system according to an embodiment of the present invention. In a system of this embodiment, an information processing apparatus and image processing apparatus can communicate with each other via a network.

Referring to FIG. 1, an information processing apparatus 100 is a PC used by a user who inputs print and FAX transmission instructions to image processing apparatuses 101 and 102. Each of the image processing apparatuses 101 and 102 includes a printer function, FAX function, copy function, scanner function, file transmission function, and the like. Assume that in this embodiment, the image processing apparatuses 101 and 102 have the same arrangement, and duplicated parts will be described taking the image processing apparatus 101 as an example. A predetermined operating system (OS) is installed in the information processing apparatus 100, and various applications (not shown) required to implement specific functional processing are also installed. Note that the specific functional processing includes document processing, spreadsheet processing, presentation processing, image processing, graphics processing, and the like, and each application includes a unique data structure (file structure).

The OS is configured to issue a print instruction to a corresponding application with reference to an identifier of each file. In the information processing apparatus 100 according to this embodiment, a device driver required to use the image processing apparatus 101 is installed. The device driver has a function of issuing output instructions such as a print instruction and FAX transmission instruction to the image processing apparatus 101, and a function of displaying a use state and execution statuses of output jobs.

The respective apparatuses are connected to a LAN (Local Area Network) 103. The respective apparatuses mutually make information communications via the LAN 103. Note that in this embodiment, the respective apparatuses are connected via the LAN 103. However, the present invention is not limited to this. A connection method is not limited to a wired/wireless connection method.

[Hardware Arrangement (Information Processing Apparatus)]

FIG. 2 is a block diagram showing an example of the hardware arrangement of the information processing apparatus 100 shown in FIG. 1. The information processing apparatus 100 includes an input device 205 which receives user operation inputs from a keyboard, pointing device, and the like. Also, the information processing apparatus 100 includes a display unit 202 which gives visual output information feedback to the user. Furthermore, the information processing apparatus 100 includes a RAM 203 as a storage device used to store various programs and execution information in this embodiment, an external memory 206 such as an HDD (Hard Disk Drive) and FDD (Flexible Disk Drive), and a ROM 204. The information processing apparatus 100 includes an interface device I/O 207 used to make communications with an external apparatus, and a CPU 201 which executes programs. Note that a connection form with an external apparatus is not limited to a wired/wireless connection. The information processing apparatus 100 is connected to the image processing apparatus 101 via this connection I/F with the external apparatus.

[Hardware Arrangement (Image Processing Apparatus)]

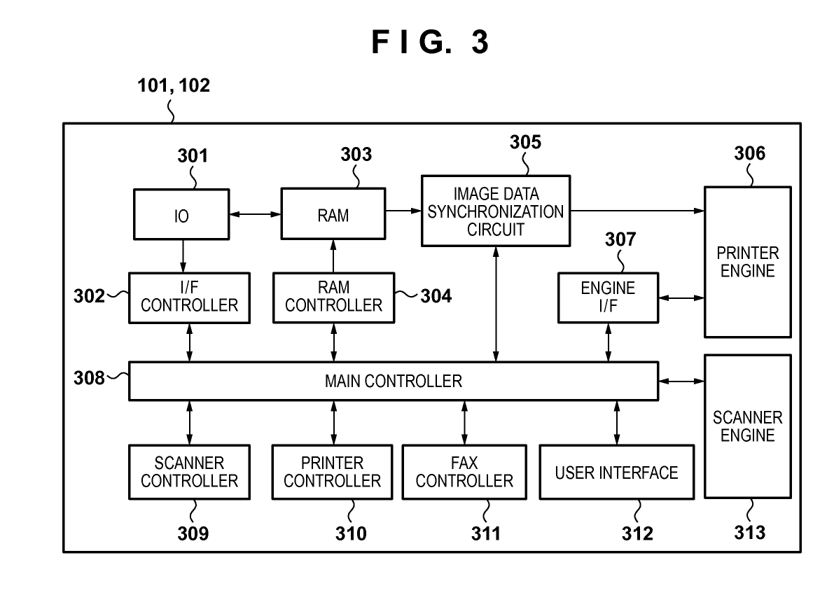

FIG. 3 is a block diagram for explaining an example of the hardware arrangement in the image processing apparatuses 101 and 102 shown in FIG. 1. Note that this embodiment will exemplify an MFP (Multi-Function Peripheral) having a scanner function, printer function, and FAX function.

Referring to FIG. 3, an I/O 301 is connected to the information processing apparatus 100 via a communication medium such as a network (LAN 103). A plurality of I/Os 301 may be included to support multiple connections. The image processing apparatus 101 passes a device ID and scan image to the information processing apparatus 100 via the I/O 301. The image processing apparatus 101 receives various control commands from the information processing apparatus 100 and executes processing.

An I/F controller 302 controls to issue a device ID in association with a processing system such as a scanner (not shown), printer (not shown), or FAX (not shown) included in the image processing apparatus 101. A RAM 303 is a primary storage device, and is used to store external data such as control commands acquired by the I/O 301, and images read by a scanner engine 313. Furthermore, the RAM 303 is used to store an image which is expanded by a printer controller 310 before it is passed to a printer engine 306.

A RAM controller 304 executes assignment management of the RAM 303. An image data synchronization circuit 305 outputs an image which is fetched by the printer controller 310 or scanner engine 313 and is expanded on the RAM controller 304 in synchronism with the rotation of the printer engine 306. The printer engine 306 is a device for developing an image on an output medium such as a paper sheet.

A main controller 308 executes various kinds of control of the printer engine 306 via an engine I/F 307. Also, the main controller 308 executes distribution processing of control languages received from the information processing apparatus 100 via the I/O 301 to a scanner controller 309, the printer controller 310, and a FAX controller 311. Furthermore, the main controller 308 controls the printer engine 306 and scanner engine 313 in response to instructions from the respective controllers and a user interface 312. By standardizing a control interface between the main controller 308 and various controllers, an extension board which can process a plurality of types of control commands can be incorporated in a single peripheral device. Also, the main controller 308 assumes a role of acquiring and managing device IDs of currently incorporated extension controllers from the respective controllers.

The scanner controller 309 converts a scan control command received from the information processing apparatus 100 into an internal executive instruction interpretable by the main controller 308. Also, the scanner controller 309 converts an image read by the scanner engine 313 into a scan control command. The printer controller 310 converts a page description language received from the information processing apparatus 100 into an internal executive instruction interpretable by the main controller 308. The converted instruction includes, for example, an expanded image, which is passed to the printer engine 306 to be printed on an output medium such as a paper sheet.

The FAX controller 311 expands a FAX control language received from the information processing apparatus 100 into an image, and transfers that image to another FAX apparatus, IP-FAX, or the like via a public line or the Internet. The user interface 312 is used as an input/output unit of various settings of the main controller 308 and user instructions upon execution of the scanner function, printer function, or FAX function by the image processing apparatus 101. The scanner engine 313 reads a printed image using an optical device in response to an instruction from the main controller 308, converts the read image into an electrical signal, and passes the electrical signal to the main controller 308.

[Software Arrangement]

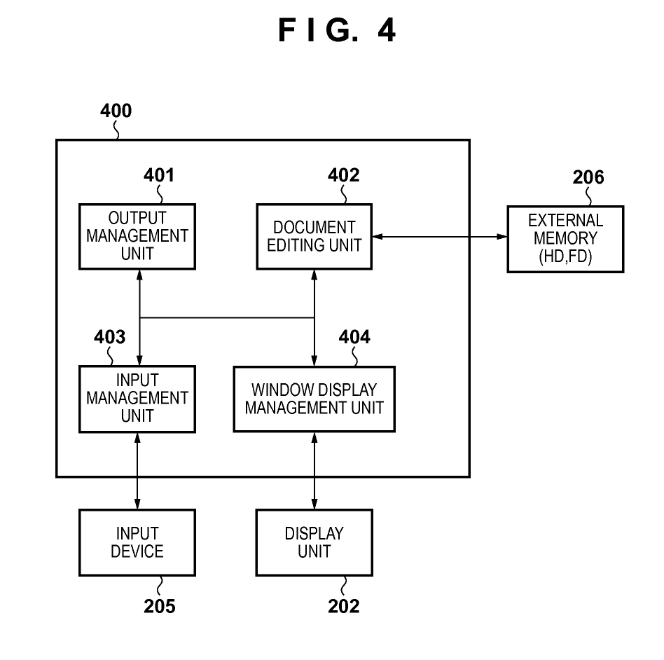

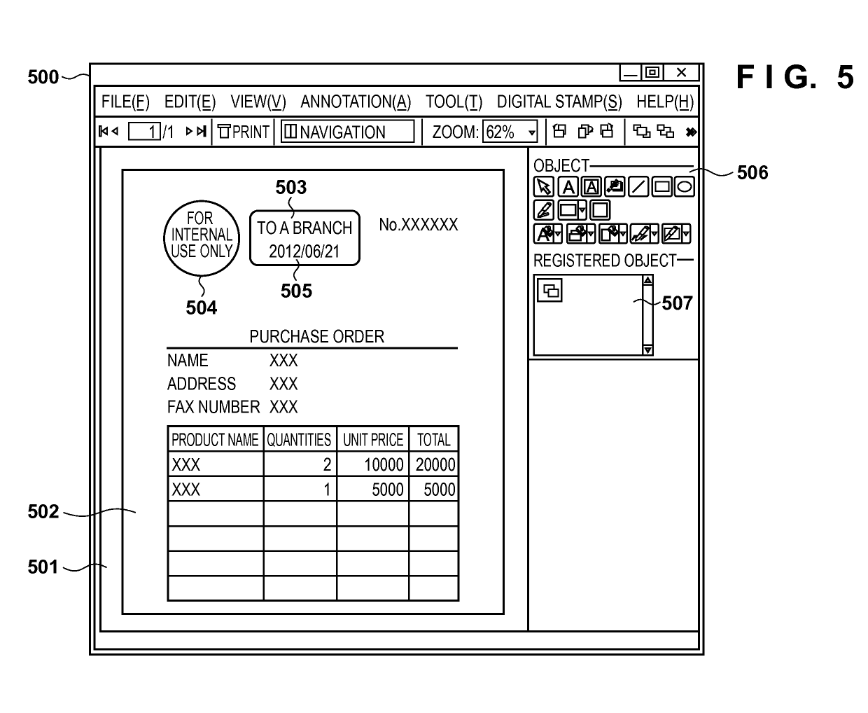

FIG. 4 is a block diagram showing an example of the functional arrangement of a document editing application 400 installed in the information processing apparatus 100. The document editing application 400 is stored in the external memory 206, and runs when it is expanded on the RAM 203 and ROM 204, and is executed by the CPU 201.

The document editing application 400 includes an output management unit 401, document editing unit 402, input management unit 403, and window display management unit 404. The output management unit 401 executes output processing of document data which is edited and stored by the document editing unit 402 to the image processing apparatus 101. More specifically, the output processing includes print processing onto a paper sheet from the printer controller 310, and FAX transmission processing from the FAX controller 311.

The document editing unit 402 appends annotation objects to document data, and editing processing of annotation objects and storage processing of document data. The input management unit 403 detects a user operation of the input device 205 via a UI (User Interface) of the document editing application 400, which is displayed by the window display management unit 404, and acquires use operation information. The window display management unit 404 executes window display control of display of the document editing application 400 and output selections as the UI of the document editing application 400.

[Display Window of Document Editing System]

FIG. 5 shows an example of a UI window of the document editing application 400. A UI window 500 is displayed by the OS. A document preview display area 501 displays a rendering result at an output timing. Original data 502 exemplifies that of a PDF (Portable Document Format) document in this embodiment. However, the present invention is not limited to such specific data.

Annotation objects 503, 504, and 505 are those appended to the original data 502. The document editing application 400 manages annotation objects as portions of the original data of the PDF document. The annotation object 503 is a text object, and is an annotation object having character string information. The annotation object 504 is a stamp object, and is an annotation object having image formation including a fixed character string.

The annotation object 505 is a date text object, and is an annotation object having character string information in a date format. In addition, various types of annotation objects such as a line, rectangle, and circle are available. When each annotation object is selected on the document preview display area 501, the annotation object itself can be moved, and its text can be edited, and various items can be changed and set depending on annotation objects. Note that in the present specification, when a plurality of annotation objects are grouped and are handled as one object, the grouped objects will be described as a group object.

When the user selects an arbitrary annotation object insertion button on an annotation object list 506, the corresponding annotation object is inserted to the original data 502. At the same time, the inserted annotation object is displayed on the document preview display area 501. On a registered object list 507, objects registered by the user are enumerated as registered objects. Each registered object has information of one or more annotation objects.

When a registered object is to be added to the registered object list 507, the user right-clicks an object displayed on the document preview display area 501. Then, the user selects “register” from a context menu (not shown) displayed at that time, thereby adding the right-clicked object to the registered object list 507 as a registered object. Note that the registration method of a registered object is not limited to this. The registered object stores an attribute of an annotation object selected at the time of registration to the registered object list 507. Then, when the registered object is to be inserted to the original data, the annotation object having the stored attribute is inserted to the original data 502.

The context menu (not shown) of the UI window 500 according to this embodiment includes an item “grouping”. When the user sets a plurality of objects in a selected state, and right-clicks the objects in the selected state, the context menu is displayed. Then, the user selects “grouping” from the context menu. Thus, the plurality of objects in the selected state are grouped. Likewise, when the user sets a plurality of objects in a selected state, and selects “registration” in place of “grouping” from the context menu displayed by right-clicking the objects in the selected state, the plurality of selected objects are grouped, thus generating a group object. In this way, the user's operability upon grouping objects can be improved.

Note that a size, layout position, and the like of each annotation object to be inserted to original data are set in correspondence with that object. Therefore, when an annotation object is registered in the registered object list 507 as a registered object, such settings may be registered together. The data structure of an annotation object will be described below.

[Data Structure of Annotation Object]

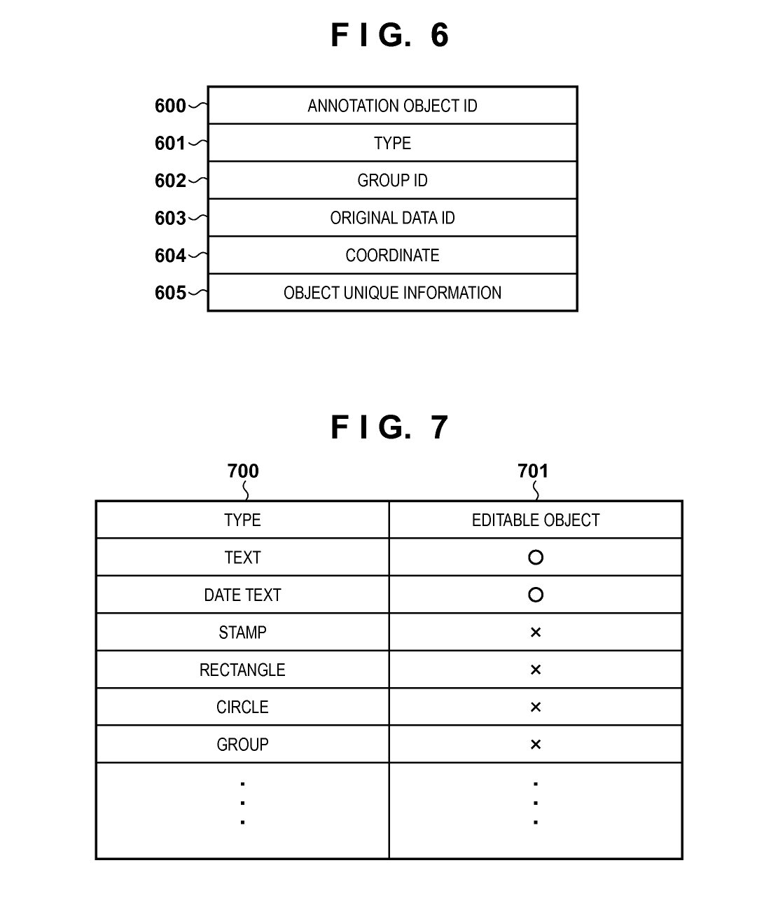

FIG. 6 shows an example of the data structure of an annotation object according to the first embodiment.

Reference numerals 600 to 605 denote pieces of attribute information of an annotation object. Note that types of attributes are not limited to them. As an annotation object ID 600, a value (identifier), which is different from those of other inserted annotation objects and is used to uniquely identify an annotation object, is assigned.

A type 601 is an attribute indicating a type, and represents that of an annotation object enumerated in the annotation object list 506. As the type 601, for example, a value of a text type for a text object, or that of a group type for a group object is set.

A group ID 602 is an attribute which represents a group ID. When annotation objects are grouped, an object ID of a group object to which that object belongs is assigned. As the group ID, a value used to uniquely identify a group is assigned. An annotation object which does not belong to any group does not have any value of the group ID 602. An annotation object may belong to a plurality of groups, and a plurality of group IDs 602 are provided to one annotation object in this case.

An original data ID 603 is an attribute which represents an original data ID, and indicates original data to which that object is inserted. As the original data ID, a unique ID used to uniquely identify original data is set.

A coordinate 604 is an attribute which indicates a coordinate position, that is, a layout position, on the original data, of that annotation object inserted to the original data. This embodiment uses a relative coordinate system having an upper left coordinate position of original data as an origin.

Object unique information 605 is an attribute related to information unique to that object, and a different value is managed depending on annotation object types. For example, a text object has character information in text, and object unique information of a group object has a list of annotation object IDs of grouped annotation objects.

FIG. 7 is a table showing whether or not respective annotation objects are editable in correspondence with attributes of the types 601 of the annotation objects. A type 700 corresponds to the attribute of the type 601 of each annotation object. An editable object 701 indicates information as to whether or not that object is editable in correspondence with the type 601. Note that the present invention is not limited to types described in FIG. 7, but other types may be defined.

In this case, the editable object is an object such as a text object having editable text information. For example, after annotation objects such as a text object and date text object are inserted to original data, character strings of text portions can be edited. By contrast, although a stamp object includes a character string, that character string cannot be edited after insertion since it is converted into an image (fixed). Note that whether or not an object is editable is not whether or not it is technically editable, but whether or not an object is editable by the document editing application 400. Hence, a stamp object may be defined as an editable object. In this case, for example, a character string of a stamp object is controlled to be editable.

[Data Structure of Registered Object]

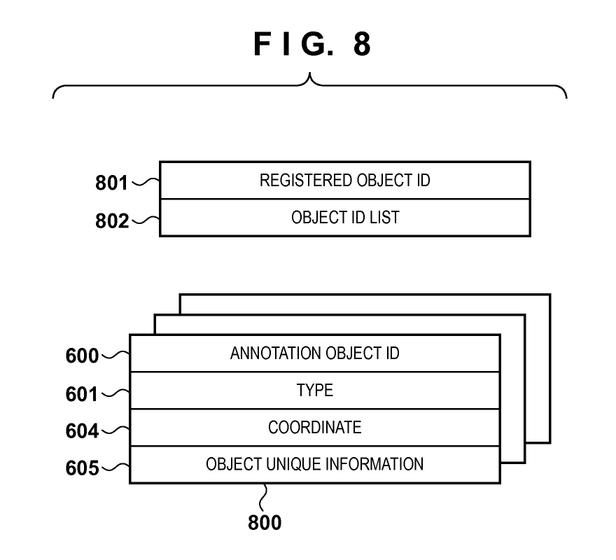

FIG. 8 shows an example of the data structure of a registered object according to the first embodiment. An annotation object 800 corresponds to each of one or a plurality of annotation objects included in a registered object. Upon generation of a registered object, information of an annotation object is generated based on information of the selected annotation object, and is added to the data structure of the registered object.

When a plurality of annotation objects are selected, one registered object has information of the plurality of annotation objects. As an annotation object ID 600 of an annotation object 800 included in a registered object, a unique value is assigned again. As a type 601 and coordinate 604 of the annotation object 800 included in the registered object, the same values as those of the selected annotation object are set. The coordinate 604 indicates an insertion position of the registered object to the original data.

Object unique information 605 of the annotation object 800 included in the registered object is decided as needed according to the type 601 of the annotation object. For example, character string information of text of a text object assumes the same value as information of the selected annotation object. List information of annotation object IDs as object unique information 605 of a group object includes annotation object IDs of a plurality of annotation objects 800 included in the registered object. Note that when the annotation object ID 600 is assigned again, as described above, the list information value is also updated.

A registered object ID 801 is associated with a registered object included in the registered object list 507, and a value which is different from those of other registered objects and is used to uniquely identify that registered object is assigned. An object ID list 802 is that of annotation object IDs 600 of annotation objects 800 included in the registered object.

[Display Upon Selection of Annotation Object]

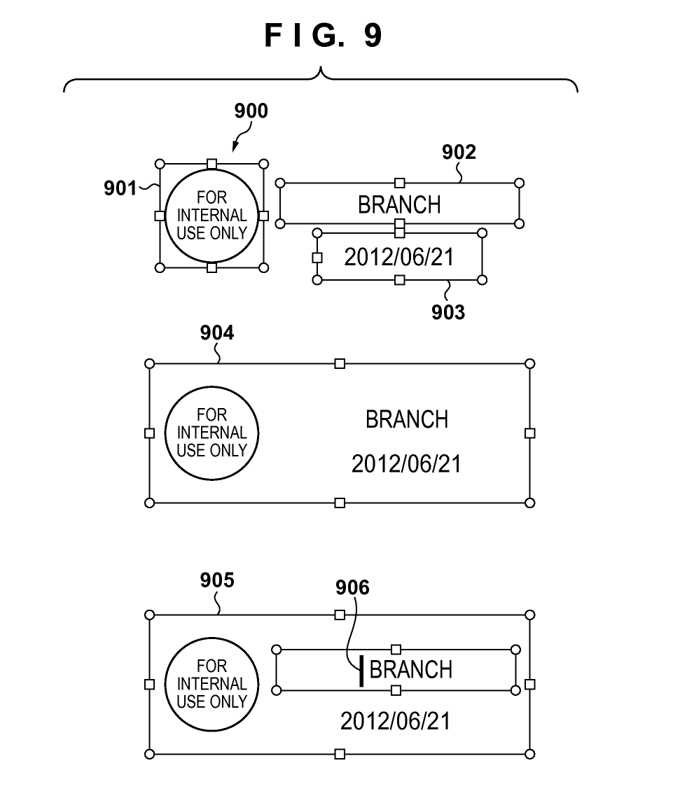

FIG. 9 shows examples of display states upon selection of annotation objects according to the first embodiment. A state 900 indicates an object selected display state in which a plurality of annotation objects 901 to 903 are selected. The annotation objects 901 to 903 are respectively a stamp object, text object, and date text object. A group object 904 indicates a display state in which a group object obtained by grouping the annotation objects 901 to 903 is selected.

A group object 905 indicates a display state when the text object 902 in the group object 904 is selected, and is set in an edit state. A cursor 906 represents a character cursor of text when the text object 902 is set in the edit state. Note that in this embodiment, the edit state allows input of a character string in a state in which the cursor 906 is displayed, but the present invention is not limited to this display format. For example, even when the cursor is not displayed, a state that allows input of characters using the input device 205 such as the keyboard need only be set.

When a group object which combines a plurality of objects is to be inserted into original data, the group object 904 is inserted while it is entirely selected. After insertion of the group object, the user selects the text object 902 in the group object 904 to set that object in an edit state so as to edit characters of the text object 902, and then edits a character string of the text object 902.

This embodiment will explain an example of an insertion method which further improves the user's operability in addition to the aforementioned insertion method. When the group object 904 is inserted to original data, a specific object (the text object 902 in this case) in the group object 905 is set in a selected state, as indicated by the group object 905. That is, in the original data to which the group object is inserted, since the text object 902 is already selected and is set in the edit state, the user need not purposely select the text object 902 to edit its character string.

[Processing Upon Generation of Registered Object]

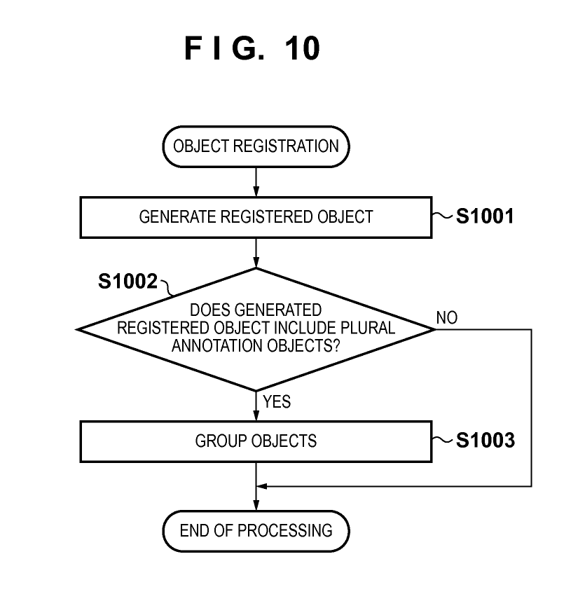

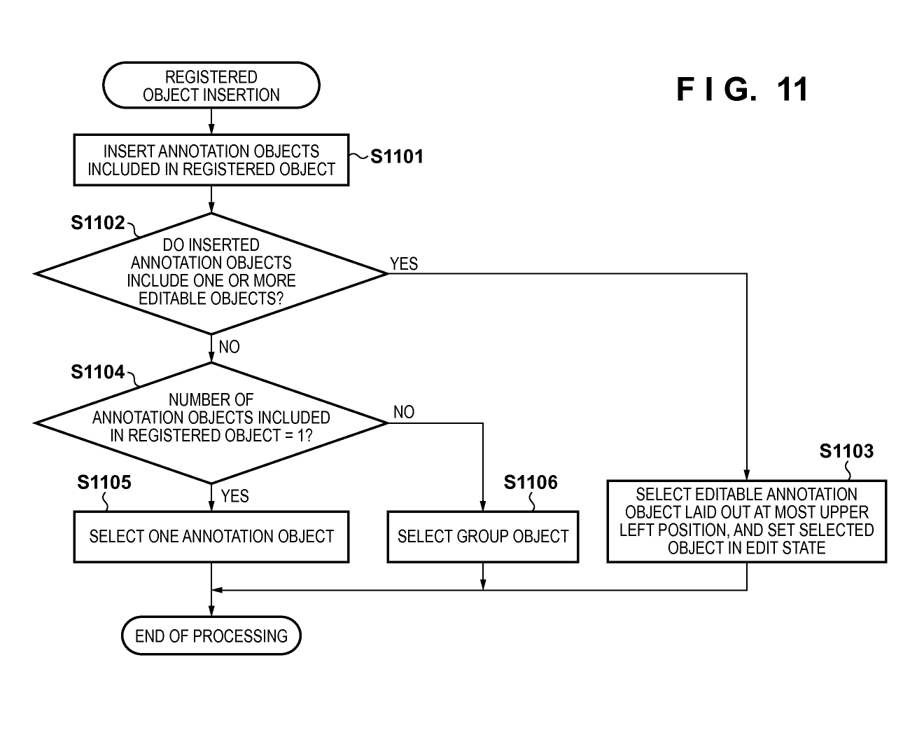

FIG. 10 is a flowchart showing processing upon generation of a registered object according to the first embodiment. FIG. 10 is executed when the user selects the annotation object 503 and the like on the document preview display area 501 of the UI window 500 of the document editing system, and generates a registered object based on the selected annotation objects. Note that the flowchart of the present application is implemented when the CPU 201 of the information processing apparatus 100 installed with the document editing application 400 reads out a corresponding program from the ROM 204 or the like and executes the readout program.

In step S1001, the document editing application 400 generates a registered object. The document editing application 400 generates the annotation object 800 of the registered object based on the selected annotation object on the document preview display area 501. At this time, when a plurality of annotation objects are selected, the registered object includes the plurality of annotation objects.

The document editing application 400 determines in step S1002 whether or not a plurality of annotation objects are included in the generated registration object. If the plurality of annotation objects are included (YES in step S1002), the process advances to step S1003; otherwise (NO in step S1002), the processing ends.

In step S1003, the document editing application 400 groups the plurality of annotation objects included in the generated registered object, thus ending the processing. More specifically, the document editing application 400 associates the plurality of annotation objects 800 of the registered object with the registered object generated in step S1001, as shown in FIG. 8.

[Processing Upon Insertion of Registered Object]

FIG. 11 is a flowchart showing processing upon insertion of a registered object according to the first embodiment. FIG. 11 is executed when the user selects a registered object in the registered object list 507 on the UI window 500 of the document editing system, and inserts that registered object on the document preview display area 501.

In step S1101, the document editing application 400 inserts an annotation object included in the registered object into original data, and displays it on the document preview display area 501. At this time, the annotation object is inserted at a position based on the value of its coordinate 604. When the registered object includes a plurality of annotation objects, the document editing application 400 inserts the plurality of annotation objects to the original data.

The document editing application 400 determines in step S1102 whether or not one or more annotation objects inserted in step S1101 include an editable object. Whether or not an editable object is included is confirmed based on the type 601 of each annotation object and the table shown in FIG. 7. If an editable object is included (YES in step S1102), the process advances to step S1103; otherwise (NO in step S1102), the process advances to step S1104.

In step S1103, if one editable object is included, the document editing application 400 inserts that editable object to the original data while setting that object in an edit state. On the other hand, if two or more editable objects are included, the document editing application 400 inserts the annotation objects to the original data while setting an editable annotation object laid out at a most upper left position in an edit state. More specifically, the document editing application 400 confirms the value of the coordinate 604 of each annotation object determined as an editable object. Then, the document editing application 400 selects an annotation object located at a position of the coordinate 604 having the smallest distance from the origin, and sets that object in an edit state. Since the processing of this step S1103 is executed, when the group object 904 is inserted to the original data, the text object 902 included in the group object 904 is inserted while being selected and set in an edit state. The position of the cursor 906 immediately after the edit state is a start position of text in this embodiment. Alternatively, the cursor 906 may be displayed at a text end position, or the text may be fully selected.

Note that in this embodiment, when the group object includes a plurality of editable annotation objects, an editable annotation object which is laid out at a most upper left position is selected in step S1103. However, the present invention is not limited to this, and an editable annotation object laid out at another position may be defined to be selected. Alternatively, a condition may be defined for settings of editable annotation objects, and an object which satisfies this condition may be selected. The condition in this case is that associated with a font size, object size, or the like.

The document editing application 400 determines in step S1104 whether or not the number of annotation objects included in the registered object is one. Note that it is guaranteed that one or more annotation objects are included in the registered object. If the number of annotation objects is one (YES in step S1104), the process advances to step S1105; if the number of annotation objects is two or more (NO in step S1104), the process advances to step S1106.

In step S1105, the document editing application 400 sets only one annotation object included in the registered object in a selected state, thus ending the processing. In step S1106, the document editing application 400 sets the entire group object in a selected state, thus ending the processing.

On the other hand, when the user presses a Tab key, the document editing application 400 may transit from the selected state of the current object to that of the next object. When the user presses the Tab key in a selected state of a group object, each annotation object included in the group object is set in a selected state after the group object. As the priority order of selected state transition, the selected state may transit in an order that prioritizes an editable object. In this manner, times and efforts required for the user who wants to set an object to be edited in a selected state can be reduced.

According to this embodiment, upon insertion of a group object, an operation load on selection of an editable object in the group by the user can be reduced.

### Second Embodiment

An embodiment required to solve a new problem posed in the first embodiment will be described below.

In the first embodiment, upon insertion of a group object, an editable object in the group is set in an edit state. Thus, the burden of operation on a user to select an editable object in the group to be set in an edit state can be reduced.

However, when the group includes a plurality of editable objects, an editable object which is not intended by the user may be set in an edit state, and the operation load on the user may not be consequently reduced. For example, as described in the first embodiment, when the group includes a plurality of editable objects, an object which is laid out at a most upper left position is selected and is set in an edit state. In this case, when the user wants to select another editable object without editing the object set in the edit state, he or she has to manually re-select the object. Furthermore, when a position to be edited by the user is not a start position of text, the user has to move a character cursor. These operations are repetitively generated every time the group object is inserted, and the same operations have to be performed each time, thus imposing a heavy load on the user.

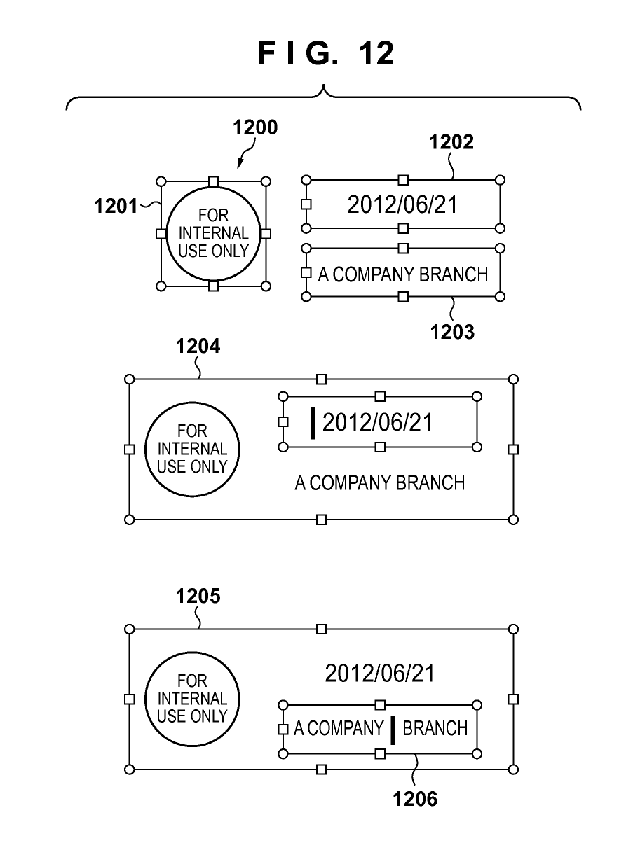

For example, when annotation objects 1201 to 1203 are selected like in a state 1200 shown in FIG. 12 to generate a registered object, the processing method of the first embodiment is executed. In this case, in a state at the time of insertion of the registered object to original data, a date text object is selected and is set in an edit state like in a group object 1204. However, when the user wants to start editing after he or she changes the date text object to the text object 1203 to be edited and moves a character cursor to a position of a cursor 1206 like in a group object 1205, the processing of the first embodiment cannot reduce the operation load on the user.

The second embodiment will explain an embodiment required to solve the aforementioned problem with reference to the drawings. Also, a description of portions having the same contents as in the first embodiment will not be given.

[Display Upon Selection of Annotation Object]

FIG. 12 shows display states upon selection of annotation objects. The state 1200 indicates a plural object selected display state of the annotation objects 1201 to 1203. The annotation objects 1201 to 1203 are respectively a stamp object, date text object, and text object.

The group object 1204 indicates an edit state upon insertion of the registered object including the annotation objects 1201 to 1203 when the method of the first embodiment is applied.

The group object 1205 indicates an edit state expected by the user upon insertion of the registered object. The cursor 1206 indicates a character cursor position of text expected by the user upon insertion of the registered object.

In case of the first embodiment, when the group object which combines the plurality of selected objects is to be inserted like in the state 1200, a selected state at the time of insertion is that of the group object 1204, that is, the date object 1202 is selected and set in an edit state.

As described above, when an object that the user wants to routinely edit is not the date object 1202 in the currently selected state but is the text object 1203, the user has to select the text object 1203. Furthermore, assume that the edit position of a character string that the user wants to select is not the start position of the text object 1203 but it is the position of the cursor 1206. In this case, the user has to perform operations for selecting the text object 1203 and then moving the character cursor position.

In this embodiment, an edit start object and edit start character cursor positions upon previous insertion of the registered object are stored as an edit history. Thus, upon next and subsequent insertions of the registered object, a document editing application inserts the group object by setting the previous edit start object in a selected state, and setting an edit state in which the character cursor is laid out at the previous edit start position. For example, from the state of the group object 1204, the user makes operations for selecting the text object 1203 in the group object 1204 and then moving the character cursor position to the state of the cursor 1206. The document editing application associates these user operations with the registered object as an edit history (1400 and 1401 in FIG. 14). After that, upon insertion of an identical group object, the document editing application refers to the edit history, thus inserting the group object in the state of the group object 1205. For this reason, the user can immediately start editing without any operations for selecting an object to be edited and moving to the character cursor position at which editing is to be started.

[Data Structure of Annotation Object]

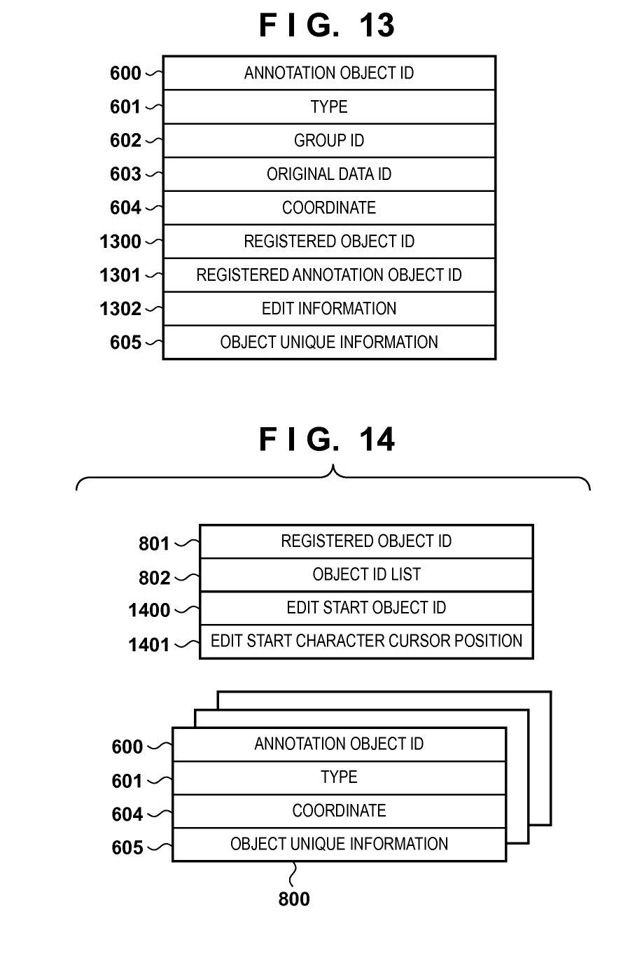

FIG. 13 shows the data structure of an annotation object according to the second embodiment. A description of the same items as those in the data structure of an annotation object described using FIG. 6 will not be repeated.

As for a registered object ID 1300, when an inserted annotation object is inserted from a registered object, a registered object ID of the insertion source is used as a registered object ID. An annotation object other than those designated to a registered object list 507, which is inserted, has no registered object ID.

When an annotation object is inserted via the registered object list 507, the target annotation object is inserted based on an annotation object included in a registered object. In this case, an annotation object ID 600 of the base annotation object included in the registered object is set as a registered annotation object ID 1301.

Edit information 1302 is that of an annotation object. The edit information 1302 indicates information used to determine whether or not the target annotation object has been edited. For example, at the edit start timing of the annotation object, information indicating that the object has been edited is indicated by the edit information 1302.

[Data Structure of Registered Object]

FIG. 14 shows an example of the data structure of a registered object according to the second embodiment. An edit start object ID 1400 is an annotation object ID of an object which is to be set in an edit state upon insertion of a registered object. An annotation object ID of one of annotation objects included in the registered object is set.

An edit start character cursor position 1401 indicates a start position of the character cursor of text to be edited if there is an object set in the edit state upon insertion of the registered object.

[Processing at Annotation Object Edit Start Timing]

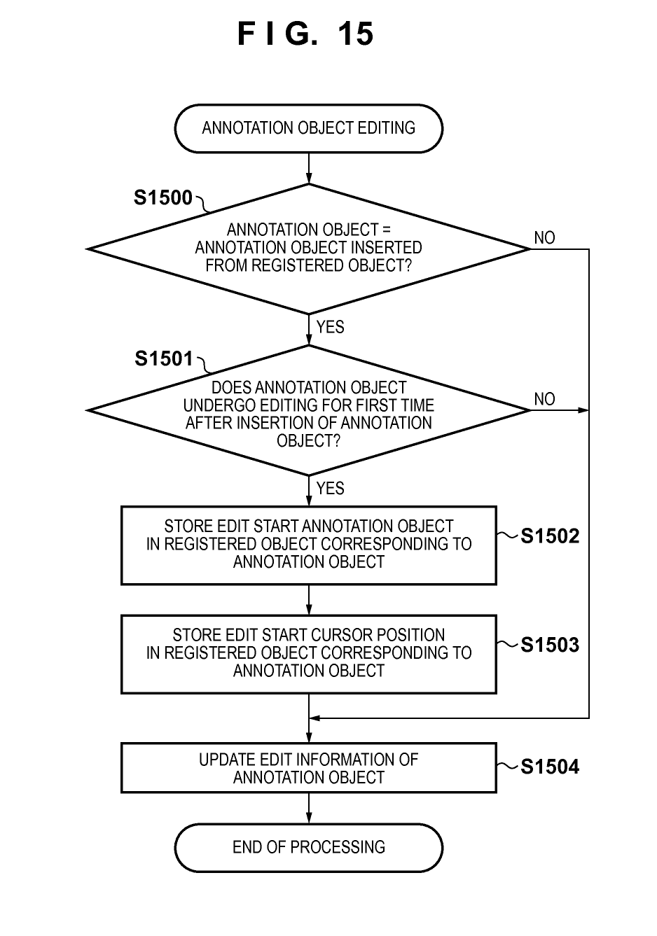

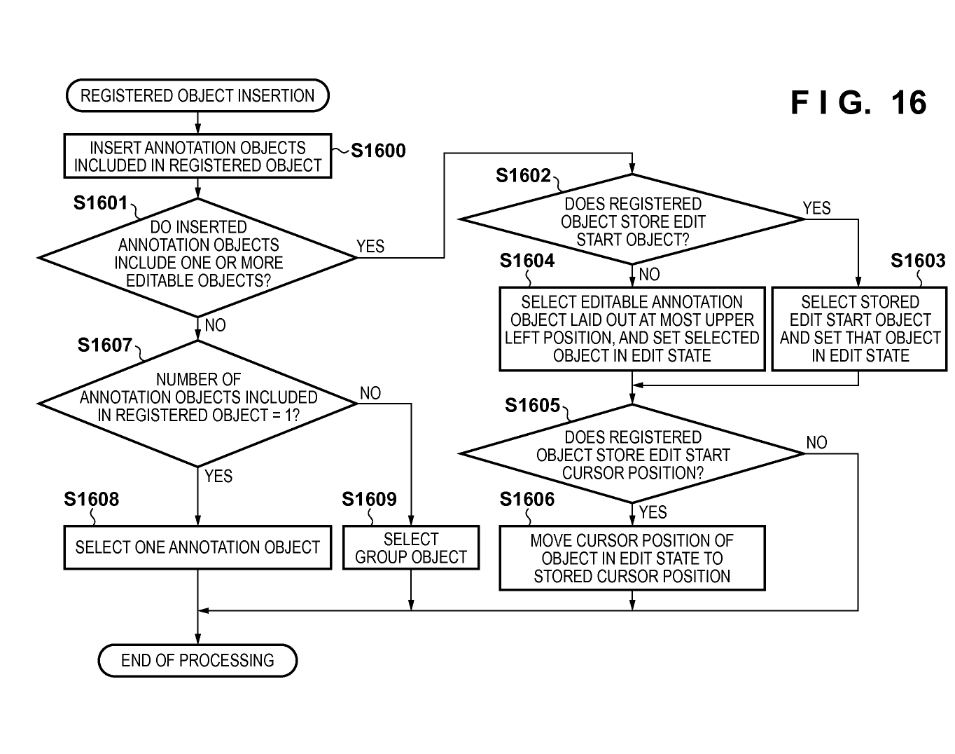

FIG. 15 is a flowchart showing the processing sequence at an annotation object edit start timing according to the second embodiment. This flowchart is executed when the user sets an annotation object on a document preview display area 501 of a document editing application 400 in an editable state and begins to edit that object.

When the user selects an annotation object, if that annotation object is an editable object, it is automatically set in an editable state. In this state, when user makes a character input, editing is started, and characters of the annotation object are edited. Note that when the user selects an annotation object, an object selected state may be set, and when he or she selects the same annotation object again, an editable state may be set.

The document editing application 400 determines in step S1500 whether or not the edit start annotation object is that inserted via the registered object list 507. More specifically, the document editing application 400 confirms if the registered object ID 1300 of that annotation object includes an ID. If the edit start annotation object is that inserted via the registered object list 507 (YES in step S1500), the process advances to step S1501; otherwise (NO in step S1500), the process jumps to step S1504.

The document editing application 400 determines in step S1501 whether or not the edit start annotation object undergoes editing for the first time after insertion of the annotation object. More specifically, the document editing application 400 records previous edit information in the edit information 1302 of the annotation object as history information. If the edit information 1302 includes no record, it can be determined that the annotation object undergoes editing for the first time. If the annotation object undergoes editing for the first time after insertion of the annotation object (YES in step S1501), the process advances to step S1502; otherwise (NO in step S1501), the process jumps to step S1504.

In step S1502, the document editing application 400 stores the edit start annotation object in a registered object corresponding to that annotation object. More specifically, the document editing application 400 detects the registered object from the registered object ID 1300 of that annotation object. Then, the document editing application 400 sets the registered annotation object ID 1301 of the edited annotation object in the edit start object ID 1400 of the detected registered object. The value of the registered annotation object ID 1301 is equal to the annotation object ID 600 of any of the annotation objects included in the registered object.

In step S1503, the document editing application 400 stores an edit start cursor position in the registered object corresponding to the annotation object. The detailed processing is the same as that of step S1502. A difference between steps S1502 and S1503 is that the edit start character cursor position is stored in the edit start character cursor position 1401 of the registered object.

In step S1504, the document editing application 400 updates the edit information 1302 of the annotation object. The document editing application 400 records information indicating that the target annotation object has been edited. More specifically, the document editing application 400 updates the edit information 1302 of the edited annotation object and of those having the same registered object ID as that of the edited annotation object.

[Processing Upon Insertion of Registered Object]

Processing upon insertion of a registered object according to this embodiment will be described below with reference to FIG. 16.

In step S1600, the document editing application 400 inserts each annotation object included in a registered object. The document editing application 400 stores the registered object ID 801 of the registered object in association with the inserted annotation object. Furthermore, the document editing application 400 stores the annotation object ID 600 of the annotation object included in the registered object as an insertion source as the registered annotation object ID 1301.

In step S1601, the document editing application 400 executes the same processing as in step S1102 of FIG. 11. If the inserted annotation objects include one or more editable objects (YES in step S1601), the process advances to step S1602; otherwise (NO in step S1601), the process advances to step S1607.

The document editing application 400 determines in step S1602 whether or not the registered object stores an edit start object. More specifically, the document editing application 400 judges whether or not the edit start object ID 1400 is set in the registered object. If the edit start object is stored (YES in step S1602), the process advances to step S1603; otherwise (NO in step S1602), the process advances to step S1604.

In step S1603, the document editing application 400 selects the stored edit start object, and sets that object in an edit state. More specifically, the document editing application 400 detects an annotation object having the annotation object ID 600 included in the registered object, which ID matches the edit start object ID 1400 of the registered object. Then, the document editing application 400 selects an annotation object inserted in correspondence with that annotation object, and sets that object in an edit state. After that, the process advances to step S1605.

In step S1604, the document editing application 400 executes the same processing as that in step S1103 of FIG. 11. The document editing application 400 determines in step S1605 whether or not the registered object stores the edit start cursor position. More specifically, the document editing application 400 judges whether or not the registered object stores the edit start cursor position 1401. If the cursor position is stored (YES in step S1605), the process advances to step S1606; otherwise (NO in step S1605), the processing ends.

In step S1606, the document editing application 400 moves the cursor position of the object in the edit state to that stored in the registered object.

In step S1607, the document editing application 400 executes the same processing as that in step S1104. If the number of annotation objects included in the registered object is one (YES in step S1607), the process advances to step S1608; otherwise (NO in step S1607), the process advances to step S1609. In step S1608, the document editing application 400 executes the same processing as that in step S1105 of FIG. 11, thus ending the processing. In step S1609, the document editing application 400 executes the same processing as that in step S1106 of FIG. 11, thus ending the processing.

In this embodiment, the edit start object and edit start character cursor position upon previous insertion of the registered object are stored, and the previously stored edit start state is automatically set upon next insertion of the registered object. Note that the object set in the edit start state is an editable object. Thus, the operation load on routine selection operations of the user can be reduced.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-188928, filed Aug. 29, 2012, which is hereby incorporated by reference herein in its entirety.

What is claimed is:

1. An information processing apparatus comprising:
a generation unit configured to generate one group object by grouping a plurality of objects; and
a layout unit configured to lay out the group object in a state that an object of a predetermined attribute of the plurality of objects included in the group object is selected.

2. The apparatus according to claim 1, further comprising a determination unit configured to determine whether or not the plurality of objects included in the group objects include a plurality of objects of the predetermined attribute,
wherein when the plurality of objects include the plurality of objects of the predetermined attribute, an object which satisfies a condition defined in advance of the plurality of objects of the predetermined attribute is set in the selected state.

3. The apparatus according to claim 2, wherein the condition is a condition related to a position of the object in the group object or a size of the object.

4. The apparatus according to claim 1, wherein the object of the predetermined attribute is an object including an editable character string, and
said layout unit sets the object of the predetermined attribute in the selected state while a character string is editable.

5. The apparatus according to claim 1, further comprising a recording unit configured to record an edit history for the plurality of objects included in the group object,
wherein when the group object is laid out on the document data, said layout unit sets a previously edited object of the plurality of objects in the selected state.

6. The apparatus according to claim 1, further comprising a registration unit configured to define and register an object setting,
wherein when said generation unit receives an instruction to register a plurality of objects in said registration unit, said generation unit generates a group object by grouping the plurality of objects.

7. An information processing method comprising:
a generation step of generating one group object by grouping a plurality of objects; and
a layout step of laying out the group object in a state that an object of a predetermined attribute of the plurality of objects included in the group object is selected.

8. The method according to claim 7, further comprising a determination step of determining whether or not the plurality of objects included in the group objects include a plurality of objects of the predetermined attribute,
wherein when the plurality of objects include the plurality of objects of the predetermined attribute, an object which satisfies a condition defined in advance of the plurality of objects of the predetermined attribute is set in the selected state.

9. The method according to claim 8, wherein the condition is a condition related to a position of the object in the group object or a size of the object.

10. The method according to claim 7, wherein the object of the predetermined attribute is an object including an editable character string, and
in the layout step, the object of the predetermined attribute is set in the selected state while a character string is editable.

11. The method according to claim 7, further comprising a recording step of recording, in a recording unit, an edit history for the plurality of objects included in the group object,
wherein in the layout step, when the group object is laid out on the document data, a previously edited object of the plurality of objects is set in the selected state.

12. The method according to claim 7, further comprising a registration step of defining and registering an object setting,
wherein in the generation step, when an instruction to register a plurality of objects in the registration step is received, a group object is generated by grouping the plurality of objects.

13. A non-transitory computer-readable medium storing a program for controlling a computer to function as:
a generation unit configured to generate one group object by grouping a plurality of objects; and
a layout unit configured to lay out the group object in a state that an object of a predetermined attribute of the plurality of objects included in the group object is selected.

14. The medium according to claim 13, wherein the program controls the computer to further function as a determination unit configured to determine whether or not the plurality of objects included in the group objects include a plurality of objects of the predetermined attribute, and
when the plurality of objects include the plurality of objects of the predetermined attribute, an object which satisfies a condition defined in advance of the plurality of objects of the predetermined attribute is set in the selected state.

15. The medium according to claim 14, wherein the condition is a condition related to a position of the object in the group object or a size of the object.

16. The medium according to claim 13, wherein the object of the predetermined attribute is an object including an editable character string, and
said layout unit sets the object of the predetermined attribute in the selected state while a character string is editable.

17. The medium according to claim 13, wherein the program controls the computer to further function as a recording unit configured to record an edit history for the plurality of objects included in the group object, and
when the group object is laid out on the document data, said layout unit sets a previously edited object of the plurality of objects in the selected state.

18. The medium according to claim 13, wherein the program controls the computer to further function as a registration unit configured to define and register an object setting, and
when said generation unit receives an instruction to register a plurality of objects in said registration unit, said generation unit generates a group object by grouping the plurality of objects.
